(19) United States
(12) Patent Application Publication
(10) Pub. No.: US 2016/0321563 A1
(43) Pub. Date: Nov. 3, 2016

(54) OPTIMIZED ARTIFICIAL INTELLIGENCE MACHINES THAT ALLOCATE PATROL AGENTS TO MINIMIZE OPPORTUNISTIC CRIME BASED ON LEARNED MODEL

(71) Applicants: Arunesh Sinha, Glendale, CA (US); Milind Tambe, Rancho Palos Verdes, CA (US); Chao Zhang, Los Angeles, CA (US)

(72) Inventors: Arunesh Sinha, Glendale, CA (US); Milind Tambe, Rancho Palos Verdes, CA (US); Chao Zhang, Los Angeles, CA (US)

(73) Assignee: UNIVERSITY OF SOUTHERN CALIFORNIA, Los Angeles, CA (US)

(21) Appl. No.: 15/144,184

(22) Filed: May 2, 2016

Related U.S. Application Data
(60) Provisional application No. 62/155,315, filed on Apr. 30, 2015.

(51) Int. Cl. G06N 99/00; G06Q 50/26

(52) U.S. Cl. CPC G06N 99/005; G06Q 50/26

(57) ABSTRACT

An optimized artificial intelligence machine may: receive information indicative of the times, locations, and types of crimes that were committed over a period of time in a geographic area; receive information indicative of the number and locations of patrol agents that were patrolling during the period of time; build a learning model based on the received information that learns the relationships between the locations of the patrol agents and the crimes that were committed; and determine whether and where criminals would commit new crimes based on the learning model and a different number of patrol agents or locations of patrol agents. The optimized artificial intelligence machine may determine an optimum location of a pre-determined number of patrolling agents to minimize the number or seriousness of crimes in a geographic area based on the learned model of the relationships between the locations of the patrol agents and the crimes that were committed, and may automatically activate or position one or more of the patrolling agents in accordance with the determination.

### CROSS-REFERENCE TO RELATED APPLICATION

This application is based upon and claims priority to U.S. provisional patent application 62/155,315, entitled “Keeping Pace with Criminals: Designing Patrol Allocation Against Adaptive Opportunistic Criminals,” filed Apr. 30, 2015, attorney docket number 094852-0091. The entire content of this application is incorporated herein by reference.

### BACKGROUND

1. Technical Field

This disclosure relates to artificial intelligence machines that allocate patrol agents to minimize opportunistic crime.

2. Description of Related Art

It can be challenging to predict crime in response to patrolling activity by police and to design patrol activity that minimizes crime over a certain geographical area.

One approach to meeting this challenge is to apply machine learning and data mining in a criminology domain to analyze crime patterns and support police in making decisions. However, this approach may only consider crime data and may not provide accurate prediction of crime, or guidance for strategic patrolling.

Another approach is Pursuit-Evasion Games (PEG). PEG may model a pursuer(s) attempting to capture an evader, often where their movement is based on a graph. However, in PEG, the evader's goal may be to avoid capture, not to seek opportunities to commit crimes, and a pursuer's goal may be to capture the evader, not to deter the criminal. Thus, PEG model may not be suitable for solving crime prediction and strategic patrolling problems.

Another approach is Stackelberg Security Games (SSG). This approach models the interaction between defender and attacker as a game and recommends patrol strategies for defenders against attackers. However, SSG may include an explicit model of the adversary which may not be consistent with actual crime and patrol data.

### SUMMARY

An optimized artificial intelligence machine may: receive information indicative of the times, locations, and types of crimes that were committed over a period of time in a geographic area; receive information indicative of the number and locations of patrol agents that were patrolling during the period of time; build a learning model based on the received information that learns the relationships between the locations of the patrol agents and the crimes that were committed; and determine whether and where criminals would commit new crimes based on the learning model and a different number of patrol agents or locations of patrol agents.

The learning model may include a Dynamic Bayesian Network that captures the relationships between the locations of the patrol agents and the crimes that were committed. A compact representation of the Dynamic Bayesian Network may be used to reduce the time of building the learning model. The compact representation may improve the determination of whether and where criminals would commit new crimes from the built learning model.

The optimized artificial intelligence machine may determine an optimum location of a pre-determined number of patrolling agents to minimize the number or seriousness of crimes in a geographic area based on the learned model of the relationships between the locations of the patrol agents and the crimes that were committed.

The determination may use a dynamic programming-based algorithm and/or an alternative greedy algorithm.

The patrolling agents may include robots. The optimized artificial intelligence machine may automatically position the robots in accordance with the determination.

The patrol agents may include security cameras. The optimized artificial intelligence machine may automatically activate or position one or more of the security cameras in accordance with the determination.

A non-transitory, tangible, computer-readable storage media may contain a program of instructions that converts a computer system having a processor when running the program of instructions into the optimized artificial intelligence machine.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a campus map of the University of Southern California.

FIG. 2 is an example of a snapshot of crime report data.

FIG. 3 illustrates a sample of summarized crime data, where each row corresponds to a shift, each column corresponds to a patrol area, and the number in each cell is the number of crimes committed during that shift in that patrol area.

FIG. 4 illustrates an example of an allocation of police officers to different patrol areas, wherein each row corresponds to an officer.

FIG. 5 illustrates an example of summarized officer patrol allocation data, where each row correspond to a shift, each column correspond to a patrol area, and the number in each cell is the number of patrol officers during that shift in that patrol area.

FIG. 6 illustrates an example of a DBN network.

FIG. 7 illustrates an example of an algorithm that may be used.

FIG. 8 illustrates an example of a comparison between an estimated numbers of crimes using different learning algorithms with a real number of crimes in 30 days.

FIG. 9 illustrates an example of a comparison between an estimated numbers of crimes using different learning algorithms with a prediction accuracy metric.

FIG. 10 compares DOGS with an actual deployed allocation strategy generated by DPS experts in USC.

FIG. 11 illustrates an example of an optimized artificial intelligence process that allocates patrol agents to minimize opportunistic crime based on a learned model.

FIG. 12 illustrates an example of an optimized artificial intelligence machine.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

A computationally fast approach for learning criminal behavior in response to patrol activity from real data will now be described, along with a design for optimal patrol activity. The approach may provide better prediction of crime and, as a result, better strategic patrols than any known prior work. The approach can be used to design and/or implement a detailed patrol strategy for a variety of patrolling assets. This patrolling strategy may be in form of GPS locations of where and when to patrol. The patrol assets may include human patrollers who follow the patrol instructions or automated mobile patrolling robots that automatically move from one GPS location to another, as well as static or movable surveillance cameras that strategically show monitoring video to a human officer sitting in a control room.

A Dynamic Bayesian Network (DBN) may model the interaction between the criminal and patrol officers and/or other types of patrol assets, such as automated robots or surveillance cameras. The DBN model may consider the temporal interaction between defender and adversary in a learning phase.

Improvements in the initial DBN model may result in a compact representation of the model that leads to better learning accuracy and increased learning speed. These improvements may include a sequence of modifications that may include marginalizing states in the DBN using approximation technique and exploiting the structure of this problem. In the compact model, the parameters may scale polynomially with the number of patrol areas, i.e., the running time may improve significantly.

Various planning algorithms may be used to enable computing the optimal officers' strategy. For example, a dynamic programming based algorithm may compute the optimal plan in a planning and updating process. As another example, a computationally faster but sub-optimal greedy algorithm may be used.

### Problem Statement

The artificial intelligence discussed herein was substantially motivated by opportunistic crimes in around the campus of University of Southern California (USC). USC has a Department of Public Safety (DPS) that conducts regular patrols, similar to police patrols in urban settings. Crime reports as well as patrol schedules on campus were studied for the last three years (2011-2013). USC is a large enough university that application of what has been discovered to other large campuses, including large mall areas.

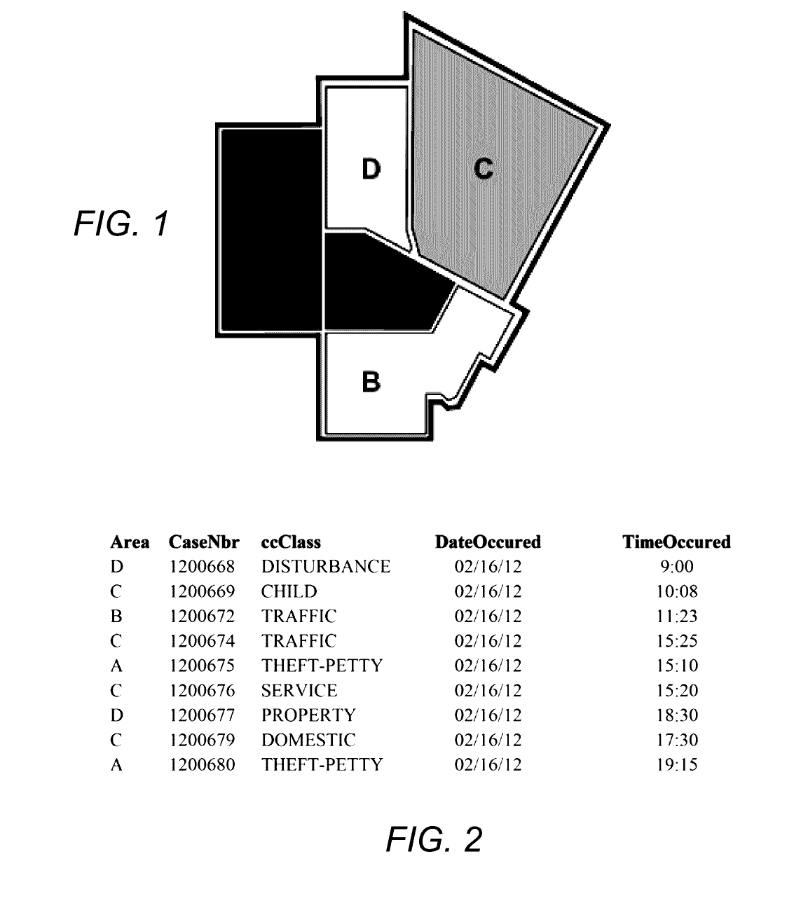

FIG. 1 illustrates an example of a campus map of USC. The campus map is divided into five patrol areas. DPS patrols in three shifts per day. In the crime data, all crimes are local, i.e., no crime happens across two patrol areas or patrol shifts. At the beginning of each patrol shift, DPS assigns each available patrol officer to a patrol area and the officer patrols this area in this shift. At the same time, the criminal is seeking crime opportunities by deciding which target they want to visit. Discussions with DPS reveal that criminals act opportunistically, i.e., crime is not planned in detail, but occurs when opportunity arises and there is insufficient presence of DPS officers.

### Data Input

There are two reports that DPS shared. The first is about criminal activity that includes details of each reported crime during the last three years, including the type of crime and the location and time information about the crime.

FIG. 2 is an example of a snapshot of crime report data.

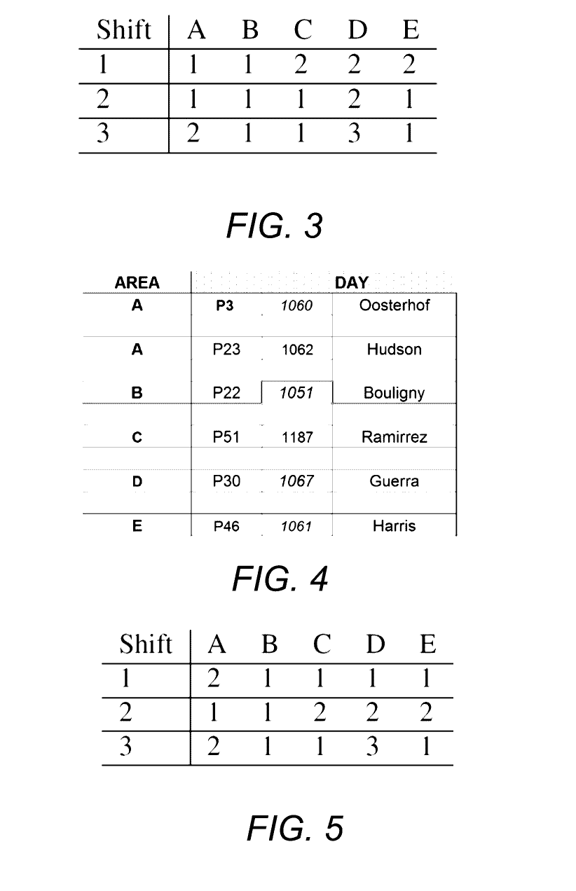

FIG. 3 illustrates a sample of summarized crime data, where each row corresponds to a shift, each column corresponds to a patrol area, and the number in each cell is the number of crimes committed during that shift in that patrol area. A three year crime report was summarized into 3285 crime data points, one for each of the 8-hour patrol shifts. Each crime data point contains five crime numbers, one for each patrol area.

FIG. 4 illustrates an example of an example of an allocation of police officers to different patrol areas, where each row corresponds to an officer. This data-set contains the DPS patrol allocation schedule. Every officer is allocated to patrolling within one patrol area. A snapshot of this data is shown in FIG. 4. All patrol officers are assumed to be homogeneous, i.e., each officer has the same effect on criminals' behavior. As a result, when generating a summary of officer patrol allocation data, only the number of officers allocated to each patrol area in each shift is recorded.

FIG. 5 illustrates an example of a sample of summarized officer patrol allocation data, where each row corresponds to a shift, each column corresponds to a patrol area, and the number in each cell is the number of patrol officers during that shift in that patrol area. For example, from FIG. 5, in shift 1, the number of officers in area A is 2, while the number of officers in areas B, C, D and E is 1. Yet, from FIG. 3, in shift 1, there was 1 crime each in area A and B, and 2 crimes each in C, D and E. However, the number of criminals in any patrol area during any patrol shift may not be known. The patrol area may be called targets, and each patrol shift may be called a time-step.

Given data such as the real world data from USC, a general learning and planning framework was built that can be used to design optimal defender patrol allocations in any comparable urban crime setting. The learning problem may be modeled as a DBN. Then, a compact form of the model that leads to improved learning performance is presented. After that, methods to find the optimal defender plan for the learnt model are presented.

### Approach

This approach learns the criminals' behavior, i.e, how the criminals choose targets and how likely they are to commit crime at that target. This behavior may in part be affected by the defenders' patrol allocation. Criminals are assumed to be homogeneous, i.e., all criminals behave in the same manner. Further, as stated earlier, the patrol officers are also homogeneous. Thus, crime may be affected only by the number of criminals and patrol officers, and not by which criminal or patrol officer is involved.

A DBN model is proposed for learning the criminals' behavior. In every time-step of the DBN, the following actions are captured: the defender assigns patrol officers to protect N patrol areas, and criminals react to the defenders' allocation strategy by committing crimes opportunistically. The probabilistic reaction of the criminals is captured as an output matrix of conditional probabilities. Across time-steps, the criminal can move from any target to any other, since a time-step is long enough to allow such a move. This aspect of criminal behavior may be captured by a transition matrix of conditional probabilities. The output and transition matrix may be parameters that describe the adversary behavior and these may need to be learned from data. From a game-theoretic perspective, the criminals' payoff may be influenced by the attractiveness of targets and the number of officers that are present. These payoffs may drive the behavior of the criminals. However, rather than model the payoffs and potential bounded rationality of the criminals, the criminal behavior may be directly learned as modeled in the DBN. For exposition, the number of targets may be denoted by N. Three random variables may be used to represent the global state for defenders, criminals and crimes at all targets:
dₜ: Defender's allocation strategy at step t: number of defenders at each target in step t.
xₜ: Criminals' distribution at step t.
yₜ: Crime distribution at step t.

Next, the unknown parameters that are to be learned may be introduced:
π: Initial criminal distribution: probability distribution of x₁.
A (movement matrix): The matrix that decides how xₜ evolves over time. Formally, A(dₜ, xₜ, xₜ₊₁)=P(xₜ₊ᵢ|dₜ, xₜ).
B (crime matrix): The matrix that decides how criminals commit crime. Formally, B(dₜ, xₜ, yₜ)=P(yₜ|dₜ, xₜ).

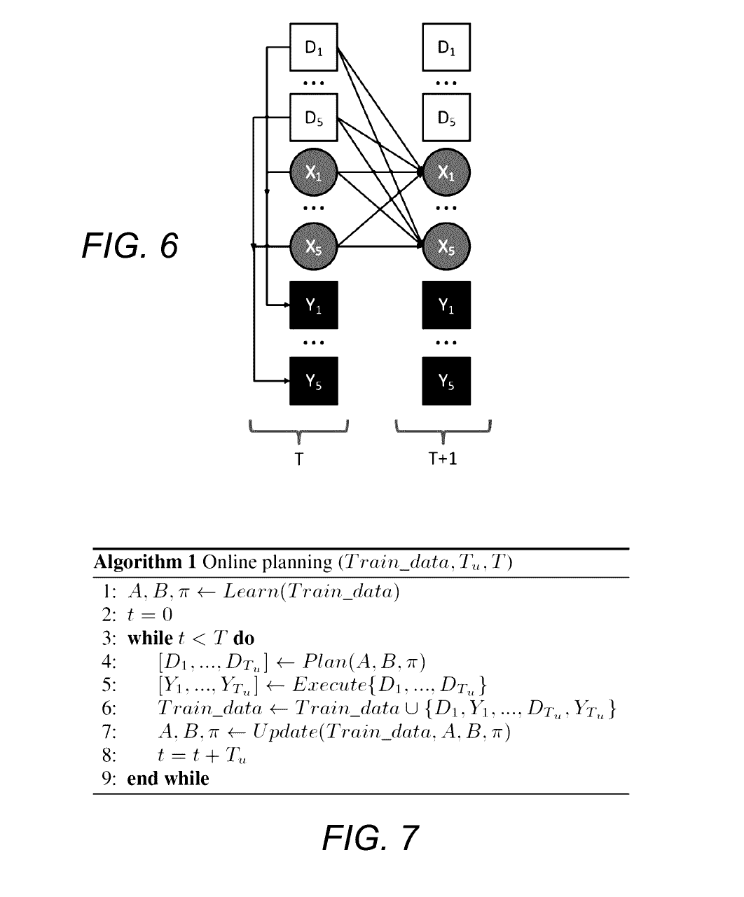

FIG. 6 illustrates an example of a DBN. The squares are observed states, where N white squares represent input states (number of defenders at each target), N black squares represent output states (number of crime at each target), and N circles (number of criminals at each target) are hidden states. The Expectation Maximization (EM) algorithm may be applied to learn the DBN. However, EM applied directly to the basic DBN model above may result in practical problems of over-fitting and exponential runtime, which may arise due to the exponential size of the output and transition matrices.

Three modifications may be made to make the model compact:
It may be inferred from the available crime data that crimes are local, i.e., crime at a particular target depends only on the criminals present at that target. Using this inference, a factored output matrix may be constructed that eliminates parameters that capture non-local crimes. The first dimension of factored crime matrix represents the target, the second dimension represents the number of defenders at this target, the third dimension represents the number of criminals and the fourth dimension represents the number of crimes. This factored crime matrix may be referred to as B, where

B(i,D_{i,t},X_{i,t},Y_{i,t})=P(Y_{i,t}|D_{i,t},X_{i,t}).
Next, intuition from the Boyen-Koller (BK) approximation may be relied upon to decompose the joint distribution of criminals over all targets into a product of independent distributions for each target. That is, the hidden state may be marginalized, i.e., instead of considering the full joint probability of criminals at all targets, a factored joint probability is considered that is a product of marginal probability of the number of criminals at each target. After marginalizing the hidden states, only N marginals may need to be kept at each step, i.e., consider only N parameters. At each step, the distribution of full state may be recovered by multiplying the marginals at this step. Then, the marginals at next step may be obtained by evolving the recovered joint distribution of state at current step. Therefore, A can be expressed as the matrix

A(dₜ,xₜ,i,X_{i,t+1})=P(x_{i,t+1}|dₜ,xₜ).
Finally, consultations with the DPS in USC and prior literature on criminology [17] demonstrate that opportunistic criminals by and large work independently. Using this independence of behavior of each criminal, the size of the transition matrix may be deduced. After these steps, the size of the output and transition may be only polynomial in the size of the problem. Based on the above observation, the probability P(X_{i,t+1}=0|Dₜ, Xₜ) may be decomposed into a product of probabilities per target m. Denote by the random variable that counts the number of criminals moving from target m to target i in the transition from time t to t+1. When X_{i,t} ε{0,1}, the whole movement matrix A may be constructed using P(X_{i,t+1}^{m→i}=0) (pairwise transition probabilities) by utilizing the fact that P(X_{i,t+1}=1|Dₜ, Xₜ)=1−P(X_{i,t+1}=0|Dₜ, Xₜ). Therefore, instead of keeping A, a transition matrix Aₘ may be kept where Aₘ (i, D_{i,t} X_{i,t}, j, X_{j,t+1})=P(X_{i,t+1}^{m→i}=0).

These three modifications cause much faster computation of the parameter values and avoids overfitting in the learning process. EM run on this compact model may be called EM on Compact model (EMC2).

The next step after learning the criminals' behavior (i.e., DBN parameters) may be to design effective officer allocation strategies against such criminals. The template for iterative learning and planning will be described before describing the planning algorithms. The criminal behavior may change when the criminal observes and figures out that the defender strategy has changed. Thus, the optimal strategy planned using the learned parameters may no longer be optimal after some time of deployment of this strategy, as the DBN parameters itself may change in response to the deployed strategy.

To address the problem above, an online planning mechanism is proposed. In this mechanism, the criminal's model may be updated based on real-time crime/patrol data and allocation strategy may be dynamically planned. The first step may be to use the initial training set to learn an initial model. Next, a planning algorithm may be used to generate a strategy for the next Tᵤ steps. After executing this strategy, more crime data may be collected and used to update the model with the original training data. By iteratively doing this, strategies for the whole horizon of T steps may be generated.

FIG. 7 illustrates an example of an algorithm that may be used. Compared to simply applying planning algorithm for T steps, this online planning mechanism may update criminals' behavior model periodically based on their response to the currently deployed strategy. In this online planning mechanism, three parts may be needed: learning algorithm, updating algorithm, and planning algorithm. For learning and updating algorithm, the EMC2 learning algorithm discussed above may be applied. In addition, a planning algorithm may also be needed, which is discussed next.

Two planning algorithms are proposed:
(1) DOGS is a dynamic programming algorithm, hence in order to find the optimal strategy for t steps, the optimal strategy for the sub-problem with t−1 steps may be found first and used to build the optimal strategy for t steps. This may be used to generate the optimal strategy for Tᵤ time steps.
(2) A greedy algorithm is presented that runs faster than the DOGS algorithm, but the solution may be sub-optimal. In greedy search, the strategy space may be split into Tᵤ slices. Then, instead of searching the optimal strategy for Tᵤ steps, only one step ahead may be looked at to search the strategy that optimize defender's utility at current step. This process may keep iterating until reaching Tᵤ steps. This greedy approach may be sub-optimal (see evaluation below).

### Output

The approach described above may output the number of patrolling assets that must be allocated to each target in any given time shift. This allocation assumes patrolling targets uniformly patrol the given target. Thus, an easy way to enable this is to make the patrolling asset traverse the area using the street map of the given geographical area (target) by covering each street once and then repeating this tour. This can be easily converted to a GPS guided tour that could be available through a phone interface.

### Evaluation

A first experiment evaluated performance of EMC2 algorithm in learning criminals' behavior. The case study of USC was used in experiments. Three years of crime report and corresponding patrol schedule followed in USC was obtained.

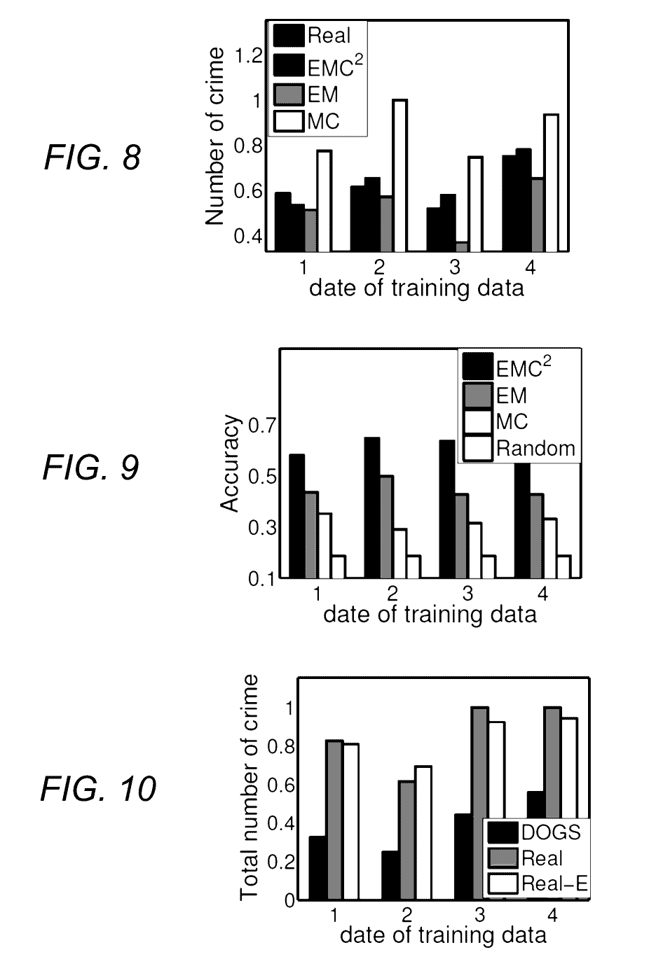

FIG. 8 illustrates an example of a comparison between the estimated numbers of crimes using different learning algorithms with the real number of crimes in 30 days. Three different algorithms are compared: (1) the Markov chain (MC) algorithm, in which the problem is modeled as a Markov chain where the states represent the number of defenders and crimes at all targets; (2) the exact EM algorithm; and (3) the EMC2 algorithm. The three year data is divided into four equal parts of nine months each. For each part, the first eight months was trained on data and tested on the ninth month data. The x-axis in this figure indicates the index of the part of data that we evaluate on. The y-axis is the total number of crimes in 30 days. The closer this number is to the real number of crime, the better the prediction is.

As can be seen, the prediction of EMC2 is much closer compared to those of EM and MC algorithm in all the training groups. This indicates that the crime distribution is related to criminals' location. Including the number of criminals at each target as a hidden state helps improve performance. In addition, the EMC2 algorithm achieves better performance than EM by reducing the number of unknown variables to avoid over-fitting.

For FIG. 9, learning performance for each individual target was measured using a metric that can be called accuracy. To define this metric, nᵢₜ may be the actual number of crimes at target i for time step t, and n′ᵢₜ my be the predicted number of crimes at target i at time step t. Then, accuracy at step t is the probability of the event Σᵢ₌₁^{N}|nᵢₜ−n′ᵢₜ|≦1. In other words, it is the probability that less than one mistake is made in predicting crimes for all N targets. The reported accuracy is the average accuracy over all t. In FIG. 8, the y-axis represents the accuracy. The higher accuracy is, the more accurate the prediction is.

Four different algorithms are compared: the MC, EM, EMC2 algorithms and the uniform random algorithm, which sets equal probability for all possible numbers of crimes at each target. As expected, the EMC2 algorithm outperforms all other algorithms in all training groups.

### DPS Experts in USC

FIG. 10 compares DOGS with the actual deployed allocation strategy generated by DPS experts in USC. Similar to the settings in FIG. 7, the three year data is divided into four equal parts of nine months. For each part, the first eight months may be trained on data using EMC2 algorithm and may test different allocation strategy on the first 10 days of the ninth month data. When testing the strategy, the criminals' behavior is assumed to remain unchanged during these 10 days. Three different scenarios are compared: (1) the real number of crimes, shown as Real in FIG. 10; (2) the expected number of crimes with the actual police strategy in University of Southern California and learned criminal behavior, shown as Real-E; and (3) the expected numbers of crime with DOGS allocation and learned criminal behavior, shown as DOGS.

As shown in FIG. 10, the expected number of crime with DPS strategy is close to the real number of crimes, which indicates EMC2 captures the main features of the criminal behavior and provides close estimate of the number of crimes. In addition, DOGS algorithm outperforms the strategy generated by domain experts significantly. This demonstrates the effectiveness of DOGS algorithm as compared to current patrol strategy. By using allocation strategy generated by DOGS, the total crime number reduces by 50% as compared to the currently deployed strategy.

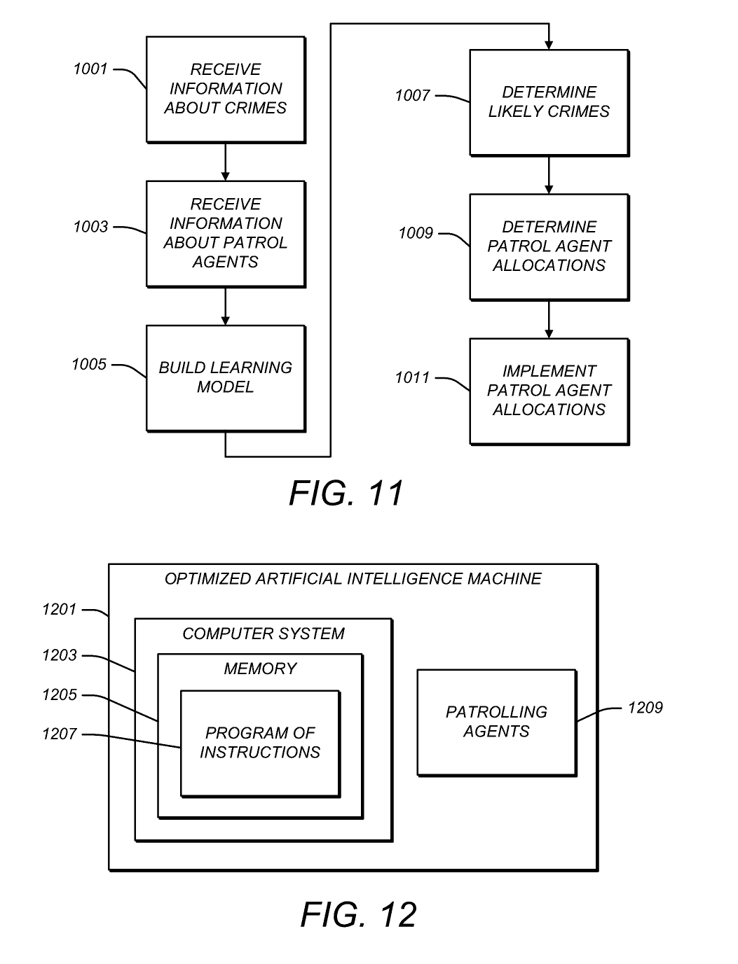

FIG. 11 illustrates an example of an artificial intelligence process that allocates patrol agents to minimize opportunistic crime based on a learned model. As illustrated in FIG. 11, the process may include: receive information about crimes 1001, such as information indicative of the times, locations, and types of crimes that were committed over a period of time in a geographic area; receive information about patrol agents 1003, such as information indicative of the number and locations of patrol agents that were patrolling during the period of time; build a learning model 1005 which may be based on the received information that learns the relationships between the locations of the patrol agents and the crimes that were committed; determine likely crimes 1007, such as whether and where criminals would commit new crimes based on the learning model and a different number of patrol agents or locations of patrol agents; determine patrol agent allocations 1009, such as an optimum location of a pre-determined number of patrolling agents to minimize the number or seriousness of crimes in a geographic area based on the learned model of the relationships between the locations of the patrol agents and the crimes that were committed; and implement patrol agent allocations 1011, such as by automatically positioning the patrol agents at the determined optimal locations. The process may include additional steps, not all of these, or one or more of the steps in a different order.

FIG. 12 illustrates an example of an optimized artificial intelligence machine 1201. As illustrated in FIG. 12, the machine may include a computer system 1203 that may include a memory 1205 containing a program of instructions 1207 that implements one or more of the algorithms and procedures discussed herein. The optimized artificial intelligence machine 1201 may also include one or more patrolling agents 1209, such as automated robots and/or cameras, that are positioned, activated, and/or oriented based on determinations of optimum positions, activations, and/or orientations determined by the artificial intelligence machine 1201. Additional systems, such as GPS navigation may be used to disseminate the output of the algorithm to patrolling assets.

The computer system 1203 may be specifically configured to perform the functions that have been described herein for it. The computer system 1203 may include one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

The computer system 1203 may be a desktop computer or a portable computer, such as a laptop computer, a notebook computer, a tablet computer, a PDA, a smartphone, or part of a larger system, such a vehicle, appliance, and/or telephone system.

The computer system 1203 may include one or more computers at the same or different locations. When at different locations, the computers may be configured to communicate with one another through a wired and/or wireless network communication system.

The computer system 1203 may include software (e.g., one or more operating systems, device drivers, application programs, such as the program of instructions 1207, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

### CONCLUSION

The approaches that have been discussed introduce a framework to design patrol allocation against adaptive opportunistic criminals. First, it models the interaction between officers and adaptive opportunistic criminals as a DBN. Next, it proposes a sequence of modifications to the basic DBN resulting in a compact model that enables better learning accuracy and running time. Finally, it presents two planning against adaptive opportunistic criminals. Experimental validation with real data supports the effectiveness of these approaches. These promising results have opened up the possibility of deploying these methods in the University of Southern California.

The various approaches that have been discussed provide artificial intelligence that allocates patrol agents to minimize opportunistic crime based on learned model. The results of this artificial intelligence may be used to automatically control the location, orientation, or other characteristics of patrolling assets, such as robots, cameras and/or drones.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently.

For example, it is also possible to consider additional factors such as occurrence of special events and economic conditions of an area in the DBN model. It may also be possible to separately predict against different types of crimes such as burglary, petty theft or murder. Further, planning patrols may consider weighing these different types of crimes differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A non-transitory, tangible, computer-readable storage media containing a program of instructions that converts a computer system having a processor when running the program of instructions into an optimized artificial intelligence machine that:
receives information indicative of the times, locations, and types of crimes that were committed over a period of time in a geographic area;
receives information indicative of the number and locations of patrol agents that were patrolling during the period of time;
builds a learning model based on the received information that learns the relationships between the locations of the patrol agents and the crimes that were committed; and
determines whether and where criminals would commit new crimes based on the learning model and a different number of patrol agents or locations of patrol agents.

2. The media of claim 1 wherein the learning model includes a Dynamic Bayesian Network that captures the relationships between the locations of the patrol agents and the crimes that were committed.

3. The media of claim 2 wherein a compact representation of the Dynamic Bayesian Network is used to reduce the time of building the learning model.

4. The media of claim 3 wherein the compact representation improves the determination of whether and where criminals would commit new crimes from the built learning model.

5. The media of claim 1 wherein the instructions cause the optimized artificial intelligence machine to determine an optimum location of a pre-determined number of patrolling agents to minimize the number or seriousness of crimes in a geographic area based on the learned model of the relationships between the locations of the patrol agents and the crimes that were committed.

6. The media of claim 5 wherein the determination uses a dynamic programming-based algorithm.

7. The media of claim 5 wherein the determination uses an alternative greedy algorithm.

8. The media of claim 5 wherein:
the patrolling agents include robots; and
the instructions cause the optimized artificial intelligence machine to automatically position the robots in accordance with the determination.

9. The media of claim 5 wherein:
the patrol agents include security cameras; and
the instructions cause the optimized artificial intelligence machine to automatically activate or position one or more of the security cameras in accordance with the determination.

10. A non-transitory, tangible, computer-readable storage media containing a program of instructions that converts a computer system having a processor running the program of instructions into an optimized artificial intelligence machine that determines an optimum location of a pre-determined number of patrolling agents to minimize the number or seriousness of crimes in a geographic area based on a learned model of relationships between locations of the patrol agents and crimes that were committed.

11. The media of claim 10 wherein the determination uses a dynamic programming-based algorithm.

12. The media of claim 10 wherein the determination uses an alternative greedy algorithm.

13. The media of claim 10 wherein:
the patrolling agents include robots; and
the instructions cause the artificial intelligence machine to automatically position the robots in accordance with the determination.

14. The media of claim 10 wherein:
the patrolling agents include security cameras; and
the instructions cause the artificial intelligence machine to automatically activate or position one or more of the security cameras in accordance with the determination.
